(19) United States
(12) Patent Application Publication
(10) Pub. No.: US 2025/0190645 A1
(43) Pub. Date: Jun. 12, 2025

(54) DESIGN METHOD FOR DISTURBANCE PIPE STRUCTURE BASED ON KARMAN VORTEX STREET THEORY

(71) Applicants: BIXDO (SH) HEALTHCARE TECHNOLOGY CO., LTD., SHANGHAI (CN); GUANG DONG BIXDO HEALTH TECHNOLOGY CO., LTD., Guangdong (CN)

(72) Inventors: Ning DING, SHANGHAI (CN); Penglei YUE, SHANGHAI (CN); Xiang ZHANG, SHANGHAI (CN); Yi LI, SHANGHAI (CN)

(21) Appl. No.: 18/728,719

(22) PCT Filed: Aug. 22, 2023
(86) PCT No.: PCT/CN2023/114283

§ 371 Date: Jul. 12, 2024

(30) Foreign Application Priority Data
Sep. 5, 2022 (CN) 202211099006.X

(51) Int. Cl. G06F 30/18

(52) U.S. Cl. CPC G06F 30/18

(57) ABSTRACT

A design method for a disturbance pipe structure based on the Karman vortex street theory, which includes a liquid transport pipe and a variable diameter disturbance element located within the liquid transport pipe. The variable diameter disturbance element includes a disturbance helical wire coiled in the direction of the liquid flow with a wire diameter of d. The design method includes the following steps: deriving an initial calculation formula for the wire diameter d according to the Reynolds number calculation formula; deriving a calculation formula for the fluid velocity V₂ of fluid entering the liquid transport pipe according to the flow conservation calculation formula; deriving the final calculation formula for the wire diameter d according to the calculation formulae between the liquid pump piston speed V₁, motor speed n, eccentric wheel eccentricity R, and the connecting rod length ratio λ (FIG. 3).

### CROSS-REFERENCE TO RELATED APPLICATIONS

The present disclosure claims priority to Chinese patent application No. 202211099006.X entitled “Design Method for Disturbance Pipe Structure based on Karman Vortex Street Theory”, filed with the CNIPA on Sep. 5, 2022, which is hereby incorporated by reference in its entirety.

### TECHNICAL FIELD

The present disclosure relates to a design method for a disturbance pipe structure based on the Karman vortex street theory.

### BACKGROUND

In order to improve heat transfer efficiency, prior-art heating modules are typically provided with springs, mostly constant diameter springs, which play a limited role in large drift diameter heating pipes.

As shown in FIG. 1 and FIG. 2, a prior-art heating module typically includes a heating pipe 01 and an electric heating spring 02 provided inside the heating pipe 01. The outer diameter of the spring coil of the electric heating spring 02 is equal along the length direction of the heating pipe 01. This can lead to the water flow in the center of the inner lumen of the heating pipe 01 not being heated, resulting in the water flow from the heating pipe 01 not being fully heated, thus causing uneven heating or fluctuating temperatures. Additionally, the prior-art electric heating modules mostly use metal for heat conduction, which poses a risk of electric leakage when in contact with water.

### SUMMARY

One purpose of an embodiment of the present disclosure is to provide a new technical solution for a design method for a disturbance pipe structure based on the Karman Vortex Street Theory.

The present disclosure provides a design method for a disturbance pipe structure based on the Karman Vortex Street Theory, which includes a liquid transport pipe and a variable diameter disturbance element provided inside the liquid transport pipe. The variable diameter disturbance element includes a disturbance helical wire 21 coiled in the direction of liquid flow with a wire diameter of d, d=Re·v/V₂, wherein: Re is the Reynolds number with a value range of 60<Re<2×10⁵, v is the fluid kinematic viscosity, and V₂ is the fluid velocity at the inlet of the liquid transport pipe.

Preferably, when the design method is applied to an oral irrigator, the disturbance pipe structure is provided downstream of the pump component of the oral irrigator, the calculation method for the wire diameter d includes the following steps:

According to the flow conservation formula V₁A₁=V₂A₂, deriving the calculation formula for the fluid velocity V₂ of fluid entering the liquid transport pipe (1): V₂=V₁A₁/A₂;

Based on the calculation formulae between the liquid pump piston speed V₁, motor speed n, eccentric wheel speed n′, gear transmission ratio i, eccentric wheel eccentricity R, and the connecting rod length ratio λ,

$$ω = 2 π {n}^{′} , \\ {n}^{′} = n / i \\ {V}_{1} = ω R [ sin ( ω t ) + \frac{λ}{2} sin ( 2 ω t ) ] , \\ {V}_{1 max} = ω R ;$$

deriving a final calculation formula for the wire diameter d:

$$d = Re \cdot v / \{ ω R [ sin ( ω t ) + \frac{λ}{2} sin ( 2 ω t ) ] \cdot {( \frac{{r}_{1}}{{r}_{2}} )}^{2} \} , \\ {d}_{min} = Re \cdot v / [ ω R \cdot {( \frac{{r}_{1}}{{r}_{2}} )}^{2} ] ;$$

wherein: d—wire diameter, dₘᵢₙ—minimum wire diameter; Re—Reynolds number, V₁—liquid pump piston speed, which is approximately equal to an initial fluid velocity, V₂—fluid velocity of fluid entering the liquid transport pipe; v—kinematic viscosity; A₁—flow cross-sectional area of a pump chamber of the liquid pump, A₂—flow cross-sectional area of a pipe lumen of the liquid transport pipe; r₁—pump chamber radius of the liquid pump, r₂—inlet end radius of the liquid transport pipe; ω—angular velocity of the eccentric wheel; n—motor speed, i—gear transmission ratio; R—eccentric distance of the eccentric wheel; λ—length-diameter ratio of a connecting rod.

Optionally, the disturbance helical wire includes N constant diameter helix segments and M variable diameter helix segments provided along the liquid flow direction of the liquid transport pipe, where when N=1, M>0; and when N>1, M≥0; the helix diameter of a segment among the constant diameter helix segments remains constant along the liquid flow direction of the liquid transport pipe, the helix diameters of any two adjacent constant diameter helix segments are different, and a helix diameter of a variable diameter helix segment varies along the liquid flow direction of the liquid transport pipe.

Optionally, let a diameter of the pipe lumen of the liquid transport pipe be D, then a spacing between a largest diameter segment among the constant diameter helix segments and a pipe wall of the liquid transport pipe ranges from 0 to 0.25 D.

Optionally, a spacing between the largest diameter segment among the constant diameter helix segments and a pipe wall of the liquid transport pipe ranges from d to 0.25 D.

Optionally, let the inner diameter of the pipe lumen of the liquid transport pipe be D, then the inner diameter of the smallest diameter segment among the constant diameter helix segments ranges from 0 to 0.5 D.

Optionally, the inner diameter of the smallest diameter segment among the constant diameter helix segments ranges from 2 d to 0.5 D.

Optionally, let the diameter of the pipe lumen of the liquid transport pipe be D, then a spacing between the variable diameter helix segment and a pipe wall of the liquid transport pipe ranges from 0 to 0.25 D, and a minimum inner diameter of the variable diameter helix segment ranges from 0 to 0.5 D.

Optionally, a spacing between the variable diameter helix segment and a pipe wall of the liquid transport pipe ranges from d to 0.25 D.

Optionally, a minimum inner diameter of the variable diameter helix segment ranges from 2 d to 0.5 D.

One technical effect of this embodiment is that:

This embodiment provides a design method for a disturbance pipe structure based on the Karman Vortex Street Theory. The designed variable diameter disturbance element with a wire diameter of d has a plurality of helix segments distributed at different radial positions of the liquid transport pipe. That is, the helix segment with the largest diameter is used to disturb the fluid near the wall, the helix segment with the smallest diameter is used to disturb the fluid at the center, and the helix segments with other diameters are used to disturb the fluid at the remaining positions. More importantly: the disturbance helical wire on both sides thereof in the radial direction of the liquid transport pipe is more likely to generate vortices, which in turn makes it easier for the liquid to mix along the radial direction of the transport pipe, thereby improving the disturbance efficiency and mixing degree of the oral rinse liquid in the liquid transport pipe. Therefore, the design method for the disturbance pipe structure based on the Karman vortex street theory disclosed in this embodiment, the variable diameter disturbance element designed by the design method is more likely to generate vortices on both sides of the disturbance helical wire in the radial direction of the liquid transport pipe, which in turn makes it easier for the liquid to mix along the radial direction of the transport pipe, thereby further improving the disturbance efficiency and mixing degree of the oral rinse liquid in the liquid transport pipe.

Other features of the present disclosure and advantages thereof may be clarified from the following detailed description of exemplary embodiments of the present disclosure with reference to the accompanying drawings.

### BRIEF DESCRIPTION OF THE DRAWINGS

FIG. 1 shows a cross-sectional view of a heating module of the prior-art;

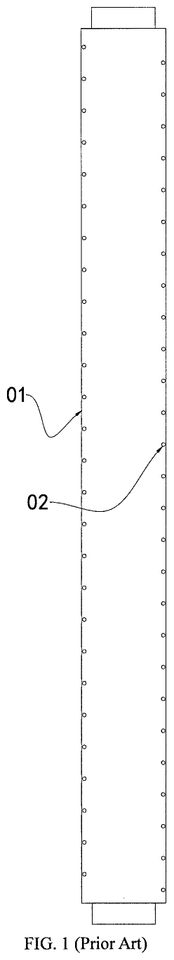

FIG. 2 shows a perspective view of an electric heating spring of the prior-art;

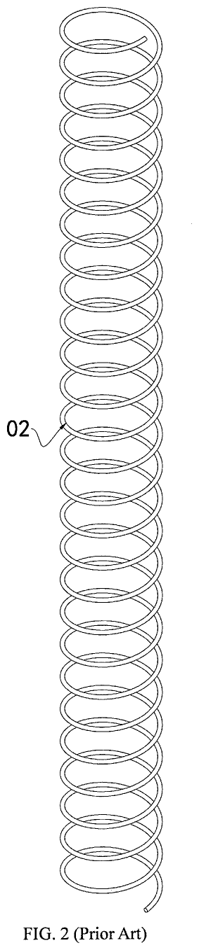

FIG. 3 shows a front view of the disturbance pipe structure of the present disclosure;

FIG. 4 shows a cross-sectional view of the disturbance pipe structure of the present disclosure;

FIG. 5 shows a front view of a first embodiment of the variable diameter disturbance element of the present disclosure;

FIG. 6 shows a front view of a second embodiment of the variable diameter disturbance element of the present disclosure;

FIG. 7 shows a schematic diagram of turbulence kinetic energy of a prior-art spring;

FIG. 8 shows a schematic diagram of turbulence kinetic energy of a first straight-through type spring designed by the design method of the present disclosure;

FIG. 9 shows a schematic diagram of turbulence kinetic energy of a first variable diameter type spring designed by the design method of the present disclosure;

FIG. 10 shows a schematic diagram of turbulence kinetic energy of a second straight-through type spring designed by the design method of the present disclosure;

FIG. 11 shows a schematic diagram of turbulence kinetic energy of a second variable diameter type spring designed by the design method of the present disclosure.

Reference Signs: Heating pipe 01; Electric heating spring 02; Liquid transport pipe 1; Inlet end 11; Outlet end 12; Variable diameter disturbance element 2; Disturbance helical wire 21; Constant diameter helix part 211; Large drift diameter helix segment 211a; Medium drift diameter helix segment 211c; Small drift diameter helix segment 211b; Variable diameter helix part 212.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

In the present disclosure, the terms “first” and “second” when used in the specification and claims may explicitly or implicitly include one or more of such features. In the description of the present disclosure, unless otherwise specified, “plurality” means two or more. Furthermore, “and/or” in the specification and claims indicates at least one of objects connected therewith, and the character “/” generally indicates that the associated objects before and after it are in an “or” relationship.

It should be understood in the description of this disclosure that if terms such as “central”, “longitudinal”, “transversal”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential”, and other directional or positional relationships are mentioned, they are based on the orientation or position shown in the drawings and are only for the convenience of describing this disclosure and simplifying the description, rather than indicating or implying that the device or component referred to must have a specific orientation, constructed and operated in a specific orientation, and therefore should not be construed as a limitation to the present disclosure.

In the description of this disclosure, it should be noted that unless there are specific provisions and limitations, the involved terms “installed”, “interconnected”, and “connected” should be understood in a broad sense. For example, it can be a fixed connection, a detachable connection, or an integral connection; it can be a mechanical connection or an electrical connection; it can be a direct connection or an indirect connection through an intermediary, and can be an internal connection between two components. For a person of ordinary skill in the art, the specific meanings of the aforementioned terms in this disclosure can be understood based on the specific circumstances.

The following describes the design method for a disturbance pipe structure based on the Karman Vortex Street Theory according to an embodiment of this disclosure, in conjunction with the drawings.

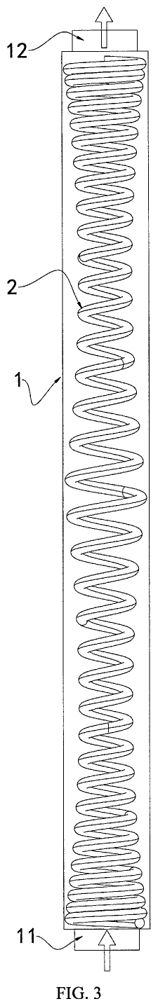

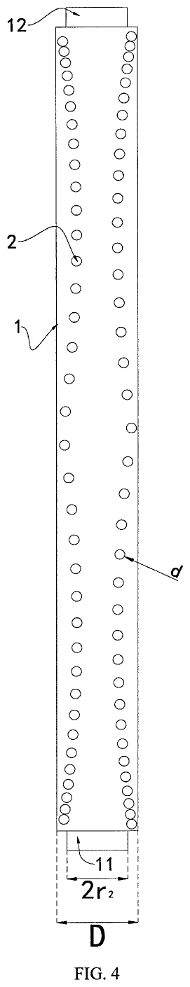

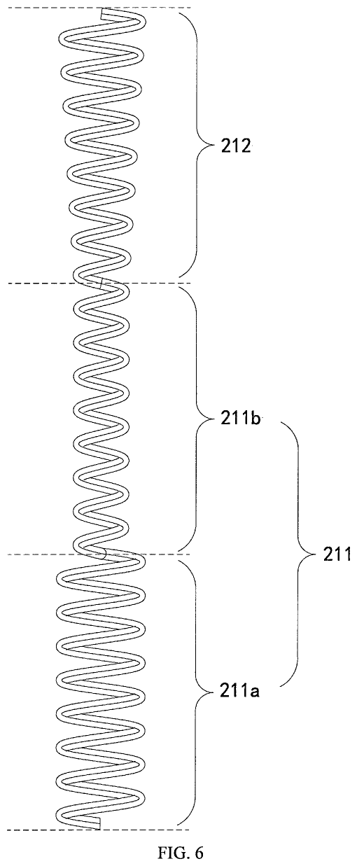

As shown in FIGS. 3, 4, 5, and 6, the disturbance pipe structure of this disclosure includes a liquid transport pipe 1 and a variable diameter disturbance element 2 provided inside the liquid transport pipe 1. The liquid transport pipe 1 has an inlet end 11 and an outlet end 12, and the diameter of the pipe lumen of the liquid transport pipe 1 is D, the radius of the inlet end 11 thereof is r₂, and the flow cross-sectional area of the inlet end 11 of the liquid transport pipe 1 is A₂=πr₂². The variable diameter disturbance element 2 includes a disturbance helical wire 21 formed by winding in the direction of the liquid flow with a wire diameter of d, on which disturbance protrusions can be provided, or it can be a smooth wire.

The oral irrigator of this disclosure includes a motor, an eccentric wheel, a liquid pump, a connecting rod, and the aforementioned disturbance pipe structure. The rotational speed of the motor is n; the eccentric wheel is in transmissional connection to the drive shaft of the motor via a small gear, the rotational speed of the eccentric wheel is n′, the eccentric distance of the eccentric wheel is R, and the angular velocity of the eccentric wheel is ω; the liquid pump includes a cylinder and a piston reciprocatively set inside the cylinder, the cylinder is in communication with the inlet end 11 of the liquid transport pipe 1, the pump chamber radius of the cylinder is r₁, and the flow cross-sectional area of the pump chamber of the cylinder is A₁=πr₁². The bottom of the connecting rod has an annular structure that cooperates with an eccentric protrusion of the eccentric wheel, which is sleeved on the eccentric wheel, the head of the connecting rod is connected to the piston, and the length-to-diameter ratio of the connecting rod is λ. In addition, the oral rinse liquid has a kinematic viscosity, which is the ratio of the kinematic viscosity of the fluid to the density p of the fluid at the same temperature, with the unit being (m\hat{ }2)/s, represented by the lowercase letter v. The kinematic viscosity v is related to temperature, see Table 1.

TABLE 1
Relationship between kinematic viscosity
(KV) and temperature (Temp)

| Temp° C. | KV [m\hat{ }2/s] |
|---|---|
| 30 | 8.009E−07 |
| 31 | 7.853E−07 |
| 32 | 7.697E−07 |
| 33 | 7.542E−07 |
| 34 | 7.386E−07 |
| 35 | 7.230E−07 |
| 36 | 7.100E−07 |
| 37 | 6.970E−07 |
| 38 | 6.840E−07 |
| 39 | 6.710E−07 |
| 40 | 6.580E−07 |

Based on the aforementioned technical foundation, this disclosure provides a design method for a disturbance pipe structure based on the Karman Vortex Street Theory, which includes the following steps:

Calculate the initial formula for the wire diameter d: d=Re·v/V₂, using the Reynolds number formula

$$Re = \frac{Vd}{v} ,$$

wherein the value range of the Reynolds number is 60<Re<2×10⁵, v is the fluid kinematic viscosity, and V₂ is the fluid velocity at the inlet of the liquid transport pipe.

When the design method is applied to an oral irrigator, the disturbance pipe structure is provided downstream of the pump component of the oral irrigator, the calculation method for the wire diameter d includes the following steps:

According to the flow conservation formula V₁A₁=V₂A₂, deriving the calculation formula for the fluid velocity V₂ of fluid entering the liquid transport pipe (1): V₂=V₁A₁/A₂;

Based on the calculation formulae between the liquid pump piston speed V₁, motor speed n, eccentric wheel speed n′, gear transmission ratio i, eccentric wheel eccentricity R, and the connecting rod length ratio λ,

$$ω = 2 π {n}^{′} , \\ {n}^{′} = n / i \\ {V}_{1} = ω R [ sin ( ω t ) + \frac{λ}{2} sin ( 2 ω t ) ] , \\ {V}_{1 max} = ω R ;$$

deriving a final calculation formula for the wire diameter d:

$$d = Re \cdot v / \{ ω R [ sin ( ω t ) + \frac{λ}{2} sin ( 2 ω t ) ] \cdot {( \frac{{r}_{1}}{{r}_{2}} )}^{2} \} , \\ {d}_{min} = Re \cdot v / [ ω R \cdot {( \frac{{r}_{1}}{{r}_{2}} )}^{2} ] ;$$

wherein: d—wire diameter, dₘᵢₙ—minimum wire diameter; Re—Reynolds number, when 60<Re<500, vortices begin to shed in the liquid transport pipe, and when 500<Re<2×10⁵, vortices shed stably in the liquid transport pipe; V—fluid velocity, V₁—liquid pump piston speed, which is approximately equal to a fluid velocity of fluid exiting the pump, V₂—fluid velocity of fluid entering the liquid transport pipe; v—kinematic viscosity; A—cross-sectional area of the pipe; A₁—flow cross-sectional area of a pump chamber of the liquid pump, A₂—flow cross-sectional area of a pipe lumen at the inlet end of the liquid transport pipe; r₁—pump chamber radius of the liquid pump, r₂—inlet end radius of the liquid transport pipe; ω—angular velocity of the eccentric wheel; n—motor speed, n′—eccentric wheel speed; R—eccentric distance of the eccentric wheel; λ—length-diameter ratio of a connecting rod.

In this disclosure, the liquid transport pipe 1 is used for transporting oral rinse liquid, the inlet end 11 of the liquid transport pipe 1 can be in communication with the storage container of the oral irrigator, and the outlet end 12 of the liquid transport pipe 1 can be in communication with the oral rinse handle of the oral irrigator, and the disturbance helical wire 21 of the variable diameter disturbance element 2 is coiled along the direction of the liquid flow in the liquid transport pipe 1. The innovation point of the design method of the present disclosure lies in the design of the wire diameter of the disturbance helical wire 21 of the variable diameter disturbance element 2:

First, based on the Reynolds number formula

$$Re = \frac{Vd}{v} ,$$

deriving an initial calculation formula for the wire diameter d: d=Re·v/V;

Then, according to the flow conservation calculation formula V₁A₁=V₂A₂, deriving a calculation formula for the fluid velocity V₂ of fluid entering the liquid transport pipe: V₂=V₁A₁/A₂;

Based on calculation formulae between the liquid pump piston speed V₁, motor speed n, eccentric wheel speed n′, gear transmission ratio i, eccentric wheel eccentricity R, and the connecting rod length ratio λ:

$$ω = 2 π {n}^{′} , \\ {n}^{′} = n / i \\ {V}_{1} = ω R [ sin ( ω t ) + \frac{λ}{2} sin ( 2 ω t ) ] , \\ {V}_{1 max} = ω R ;$$

deriving a final calculation formula for the wire diameter d:

$$d = Re \cdot v / \{ ω R [ sin ( ω t ) + \frac{λ}{2} sin ( 2 ω t ) ] \cdot {( \frac{{r}_{1}}{{r}_{2}} )}^{2} \} , \\ {d}_{min} = Re \cdot v / [ ω R \cdot {( \frac{{r}_{1}}{{r}_{2}} )}^{2} ] ;$$

The variable diameter disturbance element 2 designed by the above method, with a wire diameter of d, has multiple helix segments distributed at different radial positions of the liquid transport pipe 1. That is, the helix segment structure with the largest helix diameter is used to disturb the fluid near the wall, the helix segment structure with the smallest helix diameter is used to disturb the fluid at the center, and the helix segment structures with other sizes are used to disturb the fluid at the remaining positions. More importantly: The disturbance helical wire 21 on both sides thereof in the radial direction of the liquid transport pipe 1 is more likely to induce vortices, which in turn makes it easier for the liquid to mix radially along the conveying pipe 1, thereby improving the disturbance efficiency and mixing degree of the oral rinse liquid inside the liquid transport pipe 1.

Therefore, the variable diameter disturbance element 2 designed by the design method of the disturbance pipe structure based on the Karman vortex street theory in this disclosure is more likely to induce vortices on both sides of the disturbance helical wire 21 along the radial direction of the liquid transport pipe 1, which in turn makes it easier for the liquid to mix radially along the conveying pipe 1, thereby further improving the disturbance efficiency and mixing degree of the oral rinse liquid inside the liquid transport pipe 1.

Under normal circumstances, when the temperature of the oral rinse liquid used by the oral irrigator is 35±2° C., the user's oral comfort is relatively good. When the reciprocating frequency of the liquid pump's piston is 25 Hz, the maximum speed of the piston is V₁ₘₐₓ=0.4398 m/s, the radius r₂ of the inlet end 11 of the liquid transport pipe 1 is 3 mm, the diameter D of the pipe lumen of the liquid transport pipe 1 is 8 mm, the radius r₁ of the pump chamber of the cylinder of the liquid pump is 4.025 mm, and the fluid velocity V₂ at the inlet end 11 of the liquid transport pipe 1 is approximately 0.7917 m/s. When 60<Re<500, the wire diameter is d≥0.057 mm; when 500<Re<2×10⁵, the wire diameter is d≥0.476 mm.

To enhance the disturbance effect of the above disturbance helical wire 21, the disturbance helical wire 21 includes N constant diameter helix segments 211 and M variable diameter helix segments 212 provided along the direction of the liquid flow in the liquid transport pipe 1, wherein when N=1, M>0; when N>1, M≥0; the helix diameter of a single constant diameter helix segment 211 remains constant along the liquid flow direction of the liquid transport pipe 1, the helix diameters of any two adjacent constant diameter helix segments 211 are different, and the helix diameter of the variable diameter helix segment 212 varies along the liquid flow direction of the liquid transport pipe 1.

Since the diameter of the pipe lumen of the liquid transport pipe 1 is D, the spacing between the largest diameter segment among the constant diameter helix segments 211 and a pipe wall of the liquid transport pipe 1 ranges from 0 to 0.25 D, which allows the outer edge of the largest diameter segment among the constant diameter helix segments 211 to generate vortices. Furthermore, the spacing between the largest diameter segment among the constant diameter helix segments 211 and a pipe wall of the liquid transport pipe 1 ranges from d to 0.25 D, which further enables the outer edge of the largest diameter segment among the constant diameter helix segments 211 to generate vortices.

The inner diameter of the smallest diameter segment among the above constant diameter helix segments 211 ranges from 0 to 0.5 D, which allows the central core of the smallest diameter segment among the constant diameter helix segments 211 to generate vortices. Moreover, the inner diameter of the smallest diameter segment among the constant diameter helix segments 211 ranges from 2 d to 0.5 D, which further enables the central core of the smallest diameter segment among the constant diameter helix segments 211 to generate vortices.

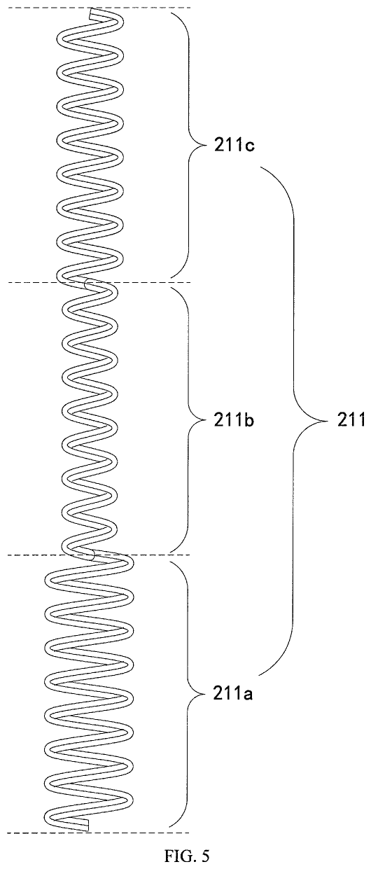

For example, as shown in FIG. 5, the above constant diameter helix segment 211 is one of the large drift diameter helix segment 211a, medium drift diameter helix segment 211c, and small drift diameter helix segment 211b, and the spacing between the large drift diameter helix segment 211a and a pipe wall of the liquid transport pipe 1 ranges from 0 to 0.25 D.

To leave a better development space for disturbance and vortex flow between the above large drift diameter helix segment 211a and a pipe wall of the liquid transport pipe 1, the spacing between the large drift diameter helix segment 211a and a pipe wall of the liquid transport pipe 1 ranges from d to 0.25 D. When the spacing between the large drift diameter helix segment 211a and a pipe wall of the liquid transport pipe 1 is 0.25 D, the vortices on both sides of the disturbance helical wire 21 along the radial direction of the liquid transport pipe 1 develop evenly. Specifically, when the large drift diameter helix segment 211a is close to a pipe wall of the liquid transport pipe 1, it is equivalent to the disturbance helical wire 21 being in the fluid's near-wall boundary layer. At low speeds, the turbulent formed is extremely weak in effect and almost only influences the near-wall boundary layer, having little disturbance effect on the high-speed liquid located at the center core of the liquid transport pipe 1. When the distance between the outer edge of the large drift diameter helix segment 211a and a pipe wall of the liquid transport pipe 1 is at least d, the disturbance helical wire 21 disturbs the medium-speed and high-speed liquids, thereby forming disturbance and thus influencing the near-wall boundary layer, improving the heat transfer efficiency of the liquid transport pipe 1 for the oral rinse liquid.

To generate vortices at the center core of the above liquid transport pipe 1, the above constant diameter helix segment 211 is one of the large drift diameter helix segment 211a, medium drift diameter helix segment 211c, and small drift diameter helix segment 211b. The inner diameter of the small drift diameter helix segment 211b ranges from 0 to 0.5 D.

To leave a better development space for disturbance and vortex flow in the above small drift diameter helix segment 211b, the inner diameter of the small drift diameter helix segment 211b ranges from 2 d to 0.5 D.

Similarly, let the inner diameter of the pipe lumen of the liquid transport pipe 1 be D, the spacing between the variable diameter helix segment 212 and a pipe wall of the liquid transport pipe 1 ranges from 0 to 0.25 D, and a minimum inner diameter of the variable diameter helix segment 212 ranges from 0 to 0.5 D. Furthermore, the spacing between the variable diameter helix segment 212 and a pipe wall of the liquid transport pipe 1 ranges from d to 0.25 D. The minimum inner diameter of the variable diameter helix segment 212 ranges from 2 d to 0.5 D.

The above disturbance helical wire 21 can be made of either non-elastic material or elastic material.

Then, a simulation analysis of the specific disturbance effect of the above disturbance helical wire 21 with a wire diameter of d is conducted: the disturbance helical wire 21 is formed by winding a metal wire. For example, a straight-through spring and a variable diameter spring with a wire diameter of 0.8 mm each, or a straight-through spring and a variable diameter spring with a wire diameter of 1.0 mm each, are obtained by the design method of the present disclosure.

The present disclosure has conducted simulation calculations on the prior-art straight spring, straight-through springs and variable diameter springs with a wire diameter of 0.8 mm each, and straight-through springs and variable diameter springs with a wire diameter of 1.0 mm each. The flow field parameters “turbulence kinetic energy”, “turbulent intensity”, and “average flow velocity” are analyzed, and the results are shown in Table 2:

TABLE 2
Disturbance Comparison Table of Prior-art Straight Spring,
Straight-through Spring, and Variable Diameter Spring

| | Size (mm) | | | | Turbulence kinetic energy [J · kg\hat{ }−1] | | | |
|---|---|---|---|---|---|---|---|---|
| | Wire | Outer | | Effec- | Body | Magnifi- | | |
| | Diam- | Diam- | | tive | Aver- | cation | | |
| Type | eter | eter | Pitch | Turns | age | times | Inlet | outlet |
| Prior | 0.35 | 7.5 | 3 | 27 | 0.0721 | | 0.0024 | 0.0996 |
| Art | | | | | | | | |
| Straight | | | | | | | | |
| Spring | | | | | | | | |
| 0.8 | 0.8 | 7.8 | 3 | 26.5 | 0.1338 | 1.86 | 0.0024 | 0.1465 |
| Straight- | | | | | | | | |
| through | | | | | | | | |
| Spring | | | | | | | | |
| 0.8 | 0.8 | 4.8-7.8 | 3 | 26.5 | 0.1036 | 1.44 | 0.0024 | 0.1095 |
| Variable | | | | | | | | |
| Diameter | | | | | | | | |
| Spring | | | | | | | | |
| 1.0 | 1 | 7.5 | 3 | 26.5 | 0.1215 | 1.69 | 0.0024 | 0.1242 |
| Straight- | | | | | | | | |
| through | | | | | | | | |
| Spring | | | | | | | | |
| 1.0 | 1 | 4.8-7.5 | 3 | 26.5 | 0.1177 | 1.63 | 0.0024 | 0.1400 |
| Variable | | | | | | | | |
| Diameter | | | | | | | | |
| Spring | | | | | | | | |

| | | | | Flow | Turbulent | |
|---|---|---|---|---|---|---|
| | Turbulence kinetic energy [J · kg\hat{ }−1] | | | Velocity | Intensity I | |
| | Magnifi- | | Magnifi- | [m/s] | | Magnifi- |
| | cation | Middle | cation | Body | Body | cation |
| Type | times | plane | times | Average | Average | times |
| Prior | | 0.0665 | | 0.5181 | 0.4232 | |
| Art | | | | | | |
| Straight | | | | | | |
| Spring | | | | | | |
| 0.8 | 1.47 | 0.1451 | 2.18 | 0.6612 | 0.4517 | 1.07 |
| Straight- | | | | | | |
| through | | | | | | |
| Spring | | | | | | |
| 0.8 | 1.10 | 0.1010 | 1.52 | 0.5752 | 0.4568 | 1.08 |
| Variable | | | | | | |
| Diameter | | | | | | |
| Spring | | | | | | |
| 1.0 | 1.25 | 0.1172 | 1.76 | 0.6114 | 0.4656 | 1.10 |
| Straight- | | | | | | |
| through | | | | | | |
| Spring | | | | | | |
| 1.0 | 1.40 | 0.1184 | 1.78 | 0.5941 | 0.4715 | 1.11 |
| Variable | | | | | | |
| Diameter | | | | | | |
| Spring | | | | | | |

The relationship formula between turbulence kinetic energy k and turbulent intensity I is:

$$k = \frac{3}{2} {( vI )}^{2} ,$$

where v is the velocity. At the same time, the greater the turbulent intensity, the more mature the disturbance development, which is a positive indicator of heat transfer efficiency. From the simulation results (i.e., data in Table 2), it can be seen that the turbulent intensities of the straight-through springs and variable diameter springs each with wire diameters of 0.8 mm and 1.0 mm are greater than those of the prior-art straight springs, and as the wire diameter d increases, the disturbance effect is enhanced, the disturbance develops more intensely, and the heat transfer efficiency is higher.

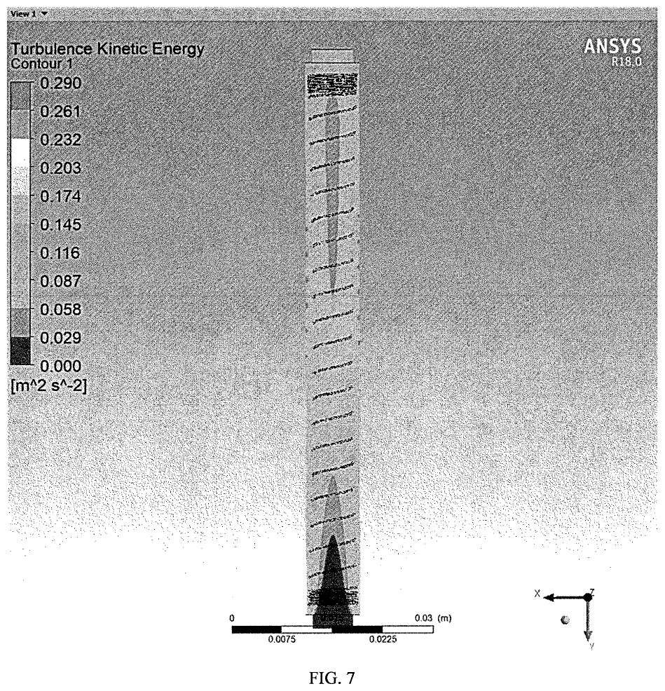

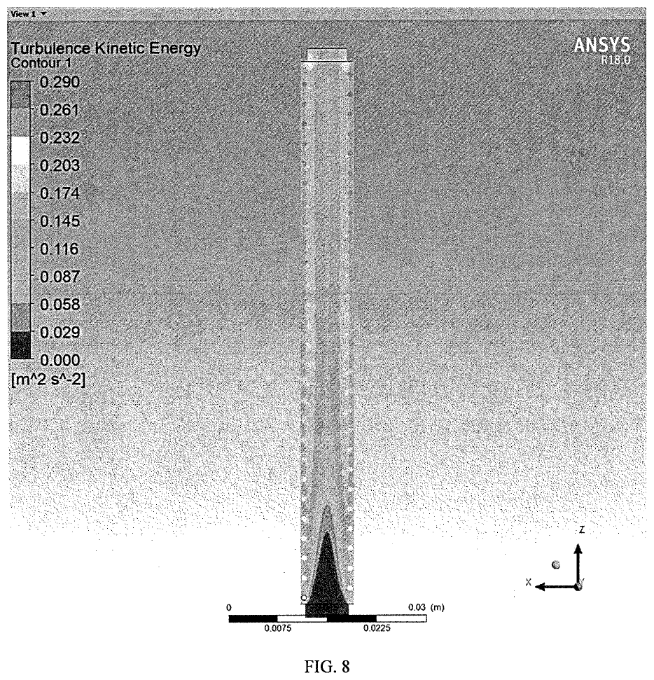

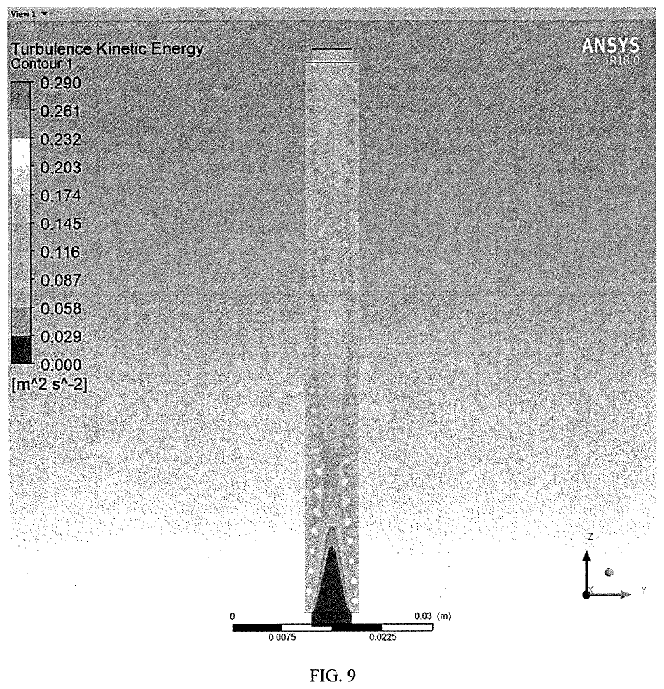

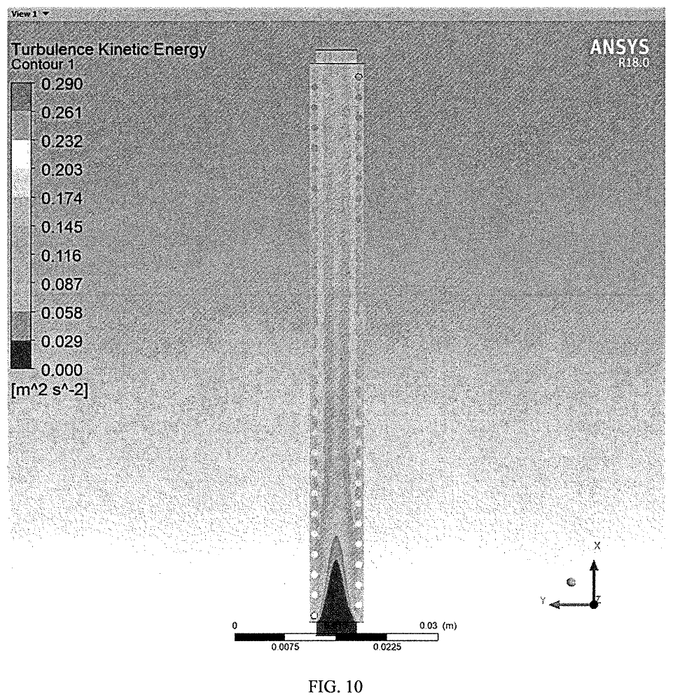

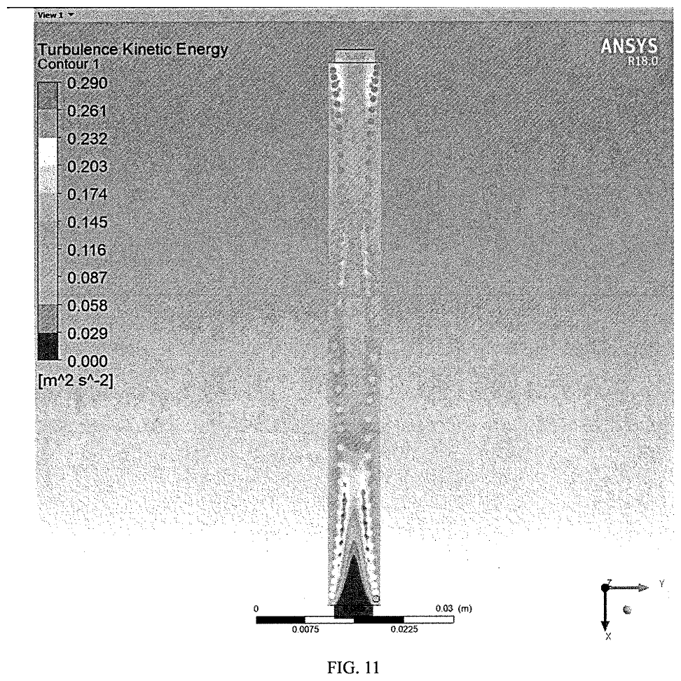

FIGS. 7, 8, 9, 10, and 11 are schematic diagrams of turbulence kinetic energy in the liquid transport pipe 1 under the action of the five types of springs.

From the schematic diagrams of turbulence kinetic energy, the following conclusions can be drawn:

1. The turbulence kinetic energy of the straight-through spring with a wire diameter of 0.8 mm (obtained by the design method of the present disclosure) is between 0.087 m²/s² to 0.232 m²/s², and the turbulence kinetic energy of the variable diameter spring with a wire diameter of 1.0 mm (obtained by the design method of the present disclosure) is between 0.087 m²/s² to 0.290 m²/s², while the turbulence kinetic energy of the prior-art straight spring is between 0.058 m²/s² to 0.087 m²/s². This means that the turbulent kinetic energies of both the straight-through springs and variable diameter springs obtained by the design method of the present disclosure are greater than that of the prior-art straight spring.

2. The variable diameter spring can disturb the high-speed liquid in the central core area of the liquid transport pipe 1, while the straight-through spring mainly influences the area near a pipe wall of the liquid transport pipe 1 and has a weaker influence on the liquid in the central core area of the liquid transport pipe 1. This may result in temperature fluctuations.

3. If the part of the variable diameter spring that gradually decreases in helix diameter along the direction of the liquid flow is arranged near the inlet end 11 of the liquid transport pipe 1, it can further disturb the fluid within the liquid transport pipe 1 and thus further improve the heat transfer efficiency.

Finally, the specific disturbance effect of the disturbance helical wire 21 with a wire diameter of d in the present disclosure is tested and analyzed:

To further verify the enhancement effect of the variable diameter spring on the heat transfer efficiency, the present disclosure conducted experimental testing. Samples of the straight-through spring and variable diameter spring each with a wire diameter of 0.8 mm were made and installed in oral irrigators No. 1, 2, 3, and 4 for temperature rise testing. The stable water temperatures at each gear position were recorded, and the statistical results are shown in Table 3. In Table 3, the cold-water temperature is 16±1° C., and the room-temperature-water temperature is 25±1° C.

TABLE 3
Water Temperature Fluctuation Table of Straight-
through Spring and Variable Diameter Spring

| | | | | | 0.8 mm | 0.8 mm |
|---|---|---|---|---|---|---|
| | | | | | Straight- | Variable |
| | Inlet Water | Gear | | Original | through | Diameter |
| Temperature | Temperature | Position | | Spring | Spring | Spring |
| Oral | Cold Water | 10 | Gears | | 35.4 | 34.4 |
| irrigator | | 5 | Gears | | 34.8 | 34.3 |
| No. 1 | | 1 | Gear | | 34.3 | 34.2 |
| | Room | 10 | Gears | | 35 | 34.7 |
| | Temperature | 5 | Gears | | 34.7 | 34.4 |
| | Water | 1 | Gear | | 34.6 | 34.4 |
| Oral | Cold Water | 10 | Gears | | 34 | 34.9 |
| irrigator | | 5 | Gears | | 34 | 34.9 |
| No. 2 | | 1 | Gear | | 34.7 | 35.2 |
| | Room | 10 | Gears | | 34.5 | 34.9 |
| | Temperature | 5 | Gears | | 34.4 | 34.7 |
| | Water | 1 | Gear | | 34.6 | 35 |
| Oral | Cold Water | 10 | Gears | 34 | | 35.2 |
| irrigator | | 5 | Gears | 35.4 | | 34.8 |
| No. 3 | | 1 | Gear | 34.9 | | 34.7 |
| | Room | 10 | Gears | 34.4 | | 34.8 |
| | Temperature | 5 | Gears | 34.6 | | 34.8 |
| | Water | 1 | Gear | 34.9 | | 34.6 |
| Oral | Cold Water | 10 | Gears | 34 | | 34.5 |
| irrigator | | 5 | Gears | 33.6 | | 34.7 |
| No. 4 | | 1 | Gear | 33.7 | | 34.7 |
| | Room | 10 | Gears | 34 | | 34.6 |
| | Temperature | 5 | Gears | 34.1 | | 34.6 |
| | Water | 1 | Gear | 34.1 | | 34.6 |

The temperature comparison between Oral irrigator No. 1 and No. 2 is shown in Table 4:

TABLE 4
Temperature Comparison Table of Oral irrigator No. 1 and No. 2

Temperature Fluctuation

| | 0.8 mm | 0.8 mm |
|---|---|---|
| 0.8 mm | Straight- | Variable |
| Straight-through Type vs | through | Diameter |
| Variable Diameter Type | Spring | Spring |

| | | | |
|---|---|---|---|
| Oral | MAX | 35.0 | 34.9 |
| irrigator | MIN | 34.0 | 34.2 |
| No. 1 | Fluctuation | 1.0 | 0.7 |
| Oral | MAX | 34.7 | 35.2 |
| irrigator | MIN | 34.0 | 34.7 |
| No. 2 | Fluctuation | 0.7 | 0.5 |

The temperature comparison between Oral irrigator No. 3 and No. 4 is shown in Table 5:

TABLE 5
**Temperature Comparison Table of
Oral irrigator No. 3 and No. 4**

Temperature
Fluctuation

| | | |
|---|---|---|
| Prior Art Straight | | 0.8 mm |
| Spring vs | Prior Art | Variable |
| 0.8 mm Variable | Straight | Diameter |
| Diameter Spring | Spring | Spring |

| | | | |
|---|---|---|---|
| Oral | MAX | 35.4 | 34.8 |
| irrigator | MIN | 34.0 | 34.5 |
| No. 3 | Fluctuation | 1.4 | 0.3 |
| Oral | MAX | 34.1 | 34.7 |
| irrigator | MIN | 33.6 | 34.5 |
| No. 4 | Fluctuation | 0.5 | 0.2 |

From the test results of Oral irrigator No. 1 and No. 2, it can be seen that the difference in stable temperature at each gear position for the 0.8 mm variable diameter spring is smaller than that for the 0.8 mm straight-through spring. This indicates that the 0.8 mm variable diameter spring has a more stable heat transfer efficiency for different gear positions compared to the straight-through spring of the same wire diameter.

From the test results of Oral irrigator No. 3 and No. 4, it can be seen that the difference in stable temperature at each gear position for the 0.8 mm variable diameter spring is significantly smaller than that for the prior-art straight spring. This indicates that the 0.8 mm variable diameter spring has a heat transfer efficiency that is several times better than that of the prior-art straight spring for different gear positions.

Therefore, the test conclusions are consistent with the simulation conclusions.

In summary, the variable diameter disturbance element designed in the present disclosure is more likely to generate vortices on both sides of the disturbance helical wire along the radial direction of the liquid transport pipe, which in turn makes it easier for the liquid to mix along the radial direction of the pipe, thereby further improving the disturbance efficiency and mixing degree of the oral rinse liquid in the liquid transport pipe. Thus, the present disclosure effectively overcomes the various shortcomings of the prior-art and has a high industrial application value.

Although the present disclosure has been described in detail in connection with some specific embodiments by way of illustration, those skilled in the art should understand that the above examples are provided for illustration only and should not be taken as any limitation on the scope of the disclosure. Those skilled in the art will appreciate that modifications may be made to the above embodiments without departing from the scope and spirit of the present disclosure. We therefore claim as our disclosure all that comes within the scope of the appended claims.

1. A design method for a disturbance pipe structure based on the Karman vortex street theory, wherein the disturbance pipe structure comprises:
a liquid transport pipe; and
a variable diameter disturbance element provided inside the liquid transport pipe,
the variable diameter disturbance element comprising a disturbance helical wire coiled in a direction of liquid flow with a wire diameter of d, d=Re·v/V₂,
wherein Re is a Reynolds number with a value range of 60<Re<2×10⁵, v is a fluid kinematic viscosity, and V₂ is a fluid velocity at an inlet end of the liquid transport pipe.

2. The design method of claim 1 for a disturbance pipe structure based on the Karman vortex street theory, wherein:
when the design method is applied to an oral irrigator, the disturbance pipe structure is provided downstream of a pump component of the oral irrigator, and a calculation method for the wire diameter d comprises the following steps:
according to the flow conservation calculation formula V₁A₁=V₂A₂, deriving a calculation formula for the fluid velocity V₂ of fluid entering at the inlet end of the liquid transport pipe (1): V₂=V₁A₁/A₂;
based on calculation formulae between the liquid pump piston speed V₁, motor speed n, eccentric wheel speed n′, gear transmission ratio i, eccentric wheel eccentricity R, and the connecting rod length ratio λ:
$$ω = 2 π {n}^{′} , \\ {n}^{′} = n / i \\ {V}_{1} = ω R [ sin ( ω t ) + \frac{λ}{2} sin ( 2 ω t ) ] , \\ {V}_{1 max} = ω R ;$$
deriving a final calculation formula for the wire diameter d:
$$d = Re \cdot v / \{ ω R [ sin ( ω t ) + \frac{λ}{2} sin ( 2 ω t ) ] \cdot {( \frac{{r}_{1}}{{r}_{2}} )}^{2} \} , \\ {d}_{min} = Re \cdot v / [ ω R \cdot {( \frac{{r}_{1}}{{r}_{2}} )}^{2} ] ;$$
wherein: d—wire diameter, dₘᵢₙ—minimum wire diameter; Re—Reynolds number, V₁—liquid pump piston speed, which is approximately equal to an initial fluid velocity, V₂—fluid velocity at the inlet end of the liquid transport pipe; v—fluid kinematic viscosity; A₁—flow cross-sectional area of a pump chamber of the liquid pump, A₂—flow cross-sectional area of a pipe lumen at the inlet end of the liquid transport pipe; r₁—pump chamber radius of the liquid pump, r₂—inlet end radius of the liquid transport pipe; ω—angular velocity of the eccentric wheel; n—motor speed, i—gear transmission ratio; R—eccentric distance of the eccentric wheel; and λ—length-diameter ratio of a connecting rod.

3. The design method of claim 1 for a disturbance pipe structure based on the Karman vortex street theory, wherein:
the disturbance helical wire comprises N constant diameter helix segments and M variable diameter helix segments provided along the liquid flow direction of the liquid transport pipe,
wherein when N=1, M>0; and when N>1, M≥0;
a helix diameter of a segment among the constant diameter helix segments remains constant along the liquid flow direction of the liquid transport pipe, helix diameters of any two adjacent constant diameter helix segments are different, and a helix diameter of a variable diameter helix segment varies along the liquid flow direction of the liquid transport pipe.

4. The design method of claim 1 for a disturbance pipe structure based on the Karman vortex street theory, wherein: when the diameter of the pipe lumen of the liquid transport pipe is D, then a spacing between a largest diameter segment among the constant diameter helix segments and a pipe wall of the liquid transport pipe is from 0 to 0.25 D.

5. The design method of claim 1 for a disturbance pipe structure based on the Karman vortex street theory, wherein: a spacing between a largest diameter segment among the constant diameter helix segments and a pipe wall of the liquid transport pipe is from d to 0.25 D.

6. The design method of claim 1 for a disturbance pipe structure based on the Karman vortex street theory, wherein: when the diameter of the pipe lumen of the liquid transport pipe is D, then the inner diameter of the smallest diameter segment among the constant diameter helix segments is from 0 to 0.5 D.

7. The design method of claim 1 for a disturbance pipe structure based on the Karman vortex street theory, wherein: the inner diameter of the smallest diameter segment among the constant diameter helix segments is from 2 d to 0.5 D.

8. The design method of claim 1 for a disturbance pipe structure based on the Karman vortex street theory, wherein: when the diameter of the pipe lumen of the liquid transport pipe is D, then a spacing between the variable diameter helix segment and a pipe wall of the liquid transport pipe is from 0 to 0.25 D, and a minimum inner diameter of the variable diameter helix segment is from 0 to 0.5 D.

9. The design method of claim 1 for a disturbance pipe structure based on the Karman vortex street theory, wherein: a spacing between the variable diameter helix segment and a pipe wall of the liquid transport pipe is from d to 0.25 D.

10. The design method of claim 1 for a disturbance pipe structure based on the Karman vortex street theory, wherein: a minimum inner diameter of the variable diameter helix segment is from 2 d to 0.5 D.
